(19) United States
(12) Patent Application Publication
(10) Pub. No.: US 2026/0260441 A1
(43) Pub. Date: Sep. 3, 2026

(54) SYSTEM

(71) Applicant: SOFTBANK GROUP CORP., Tokyo (JP)

(72) Inventor: Tsukasa KUSAKABE, Tokyo (JP)

(73) Assignee: SOFTBANK GROUP CORP., Tokyo (JP)

(21) Appl. No.: 19/554,721

(22) Filed: Mar. 3, 2026

Related U.S. Application Data
(60) Provisional application No. 63/766,190, filed on Mar. 3, 2025.

(51) Int. Cl. G06T 19/20; G06F 40/40; G06T 15/00; G06T 17/00; G06T 19/00

(52) U.S. Cl. CPC G06T 19/20; G06F 40/40; G06T 15/005; G06T 17/00; G06T 19/003; G06T 2210/56; G06T 2219/2004

(57) ABSTRACT

A system that generates room layouts suitable for real environments based on user preferences is disclosed. Users input their desired room style and color scheme using a terminal and acquire 3D scan data of the room using LiDAR technology. This enables accurately determinng the room's dimensions and shape. A generative AI then proposes an optimal layout based on historical data. Based on the generated layout, specific furniture and appliances are proposed, and users can obtain information to purchase them. Furthermore, in commercial facilities, product placement based on behavioral economics is proposed to promote customer purchasing behavior. This enables both individuals and businesses to reduce time and costs while improving customer satisfaction and sales.

### CROSS-REFERENCE TO RELATED APPLICATION

This application claims priority under 35 U.S.C. § 119 to U.S. Provisional Patent Application No. 63/766,190, filed on March 3, 2025, the entire contents of which are incorporated herein by reference.

### BACKGROUND

### Technical Field

The present disclosure relates to a system.

### Related Art

Japanese Patent Application Publication Laid-Open (JP-A) No. 2022-180282 discloses a persona chatbot control method performed by at least one processor, comprising: a step of receiving a user utterance; a step of adding to the user utterance a prompt containing a description of the chatbot's persona and related instructions; a step of encoding the prompt; and a step of inputting the encoded prompt into a language model to generate a chatbot utterance in response to the user utterance.

### SUMMARY

Conventionally, room layout design involved significant manual work by specialists, consuming considerable time and cost, and it was difficult to fully reflect users' specific preferences and the physical constraints of the room. Furthermore, in commercial facilities, finding the optimal arrangement considering the impact of product and shelf placement on sales was difficult. It is desired that the speedy proposal of layouts reflecting the user's desired style and atmosphere by utilizing generative AI is generated. Based on real-environment data acquired using LiDAR technology, generative AI may also enables the proposal of specific furniture and appliances that match the room's dimensions and shape. Furthermore, its behaviorally-driven placement proposal function promotes customer purchasing behavior in commercial facilities, enabling optimal product placement that contributes to increased sales. This achieves time and cost savings, enhanced customer satisfaction, and increased sales for both individuals and businesses.

As a means to solve the problem, a system comprising: an input unit that accepts user input; a data acquisition unit that acquires real-world environmental data of the target room; a layout generation unit that generates room layouts using generative AI; and a proposal unit that proposes specific furniture and appliances based on the generated layouts is proposed. The input unit accepts information such as the desired room style, color scheme, and atmosphere via a chat-based interface and analyzes it using natural language processing technology.

The data acquisition unit accurately determines the room's dimensions and shape using 3D scan data, images, and videos acquired via LiDAR technology. The layout generation unit integrates the user's preferences with the real-environment data and generates the optimal room layout based on various room layout data learned from past cases. The proposal unit selects specific furniture and appliances actually sold by manufacturers based on the generated layout and proposes them to the user. This enables the rapid provision of practical and effective layouts aligned with the user's preferences.

### BRIEF DESCRIPTION OF THE DRAWINGS

FIG. 1 is a conceptual diagram showing an example configuration of the data processing system according to the first embodiment.

FIG. 2 is a conceptual diagram showing an example of the main functions of the data processing device and smart device according to the first embodiment.

FIG. 3 is a conceptual diagram showing an example configuration of the data processing system according to the second embodiment.

FIG. 4 is a conceptual diagram showing an example of the main functions of the data processing device and smart glasses according to the second embodiment.

FIG. 5 is a conceptual diagram showing an example configuration of a data processing system according to a third embodiment.

FIG. 6 is a conceptual diagram showing an example of the main functions of the data processing device and headset-type terminal according to the third embodiment.

FIG. 7 is a conceptual diagram showing an example configuration of a data processing system according to the fourth embodiment.

FIG. 8 is a conceptual diagram showing an example of the main functions of the data processing device and robot according to the fourth embodiment.

FIG. 9 shows an emotion map onto which multiple emotions are mapped.

FIG. 10 shows an emotion map onto which multiple emotions are mapped.

### DETAILED DESCRIPTION

The following describes an example embodiment of a system according to the present disclosure with reference to the accompanying drawings.

First, the terminology used in the following description is explained.

In the following embodiments, a processor (hereinafter simply referred to as a "processor") may be a single arithmetic unit or a combination of multiple arithmetic units. Furthermore, the processor may be a single type of arithmetic unit or a combination of multiple types of arithmetic units. Examples of processing units include a CPU (Central Processing Unit), a GPU (Graphics Processing Unit), a GPGPU (General-Purpose computing on Graphics Processing Units), an APU (Accelerated Processing Unit), and the like.

In the following embodiments, signed RAM (Random Access Memory) is a memory where information is temporarily stored and is used as working memory by the processor.

In the following embodiments, the signed storage is one or more non-volatile storage devices that store various programs and various parameters, etc. Examples of non-volatile storage devices include flash memory (SSD (Solid State Drive)), magnetic disks (e.g., hard disk), or magnetic tape.

In the following embodiments, the communication I/F (Interface) is an interface that includes a communication processor and an antenna, among other components. The communication I/F governs communication between multiple computers. Examples of communication standards applicable to the communication I/F include wireless communication standards such as 5G (5^{th} Generation Mobile Communication System), Wi-Fi (registered trademark), or Bluetooth (registered trademark).

In the following embodiments, "A and/or B" is synonymous with "at least one of A and B." That is, "A and/or B" may mean A alone, B alone, or a combination of A and B. Furthermore, in this specification, when three or more items are connected using "and/or," the same concept applies as for "A and/or B".

### First Embodiment

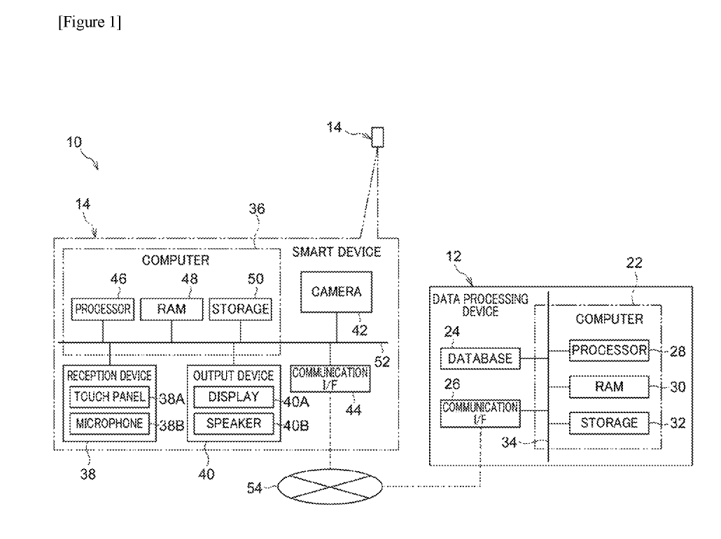

FIG. 1 shows an example configuration of a data processing system 10 according to the first embodiment.

As shown in FIG. 1, the data processing system 10 includes a data processing device 12 and a smart device 14. An example of the data processing device 12 is a server.

The data processing device 12 includes a computer 22, a database 24, and a communication I/F 26. The computer 22 is an example of a "computer" according to the technology of the present disclosure. The computer 22 includes a processor 28, RAM 30, and storage 32. The processor 28, RAM 30, and storage 32 are connected to a bus 34. The database 24 and communication I/F 26 are also connected to the bus 34. The communication I/F 26 is connected to a network 54. An example of the network 54 include a WAN (Wide Area Network) and/or a LAN (Local Area Network).

The smart device 14 includes a computer 36, a reception device 38, an output device 40, a camera 42, and a communication I/F 44. The computer 36 includes a processor 46, RAM 48, and storage 50. The processor 46, RAM 48, and storage 50 are connected to a bus 52. The reception device 38, output device 40, and camera 42 are also connected to the bus 52. The reception device 38, output device 40, and camera 42 are also connected to the bus 52.

The reception device 38 includes a touch panel 38A and a microphone 38B, among other components, and receives user input. The touch panel 38A receives user input via contact with an indicator (e.g., a pen or finger) by detecting such contact. The microphone 38B receives voice-based user input by detecting the user's voice. The control unit 46A transmits data indicating the user input received via the touch panel 38A and microphone 38B to the data processing unit 12. Within the data processing unit 12, the specific processing unit 290 acquires the data indicating the user input.

Output device 40 includes display 40A and speaker 40B, among others, and presents data to user 20 by outputting it in a form perceptible to user 20 (e.g., audio and/or text). Display 40A displays visual information such as text and images according to instructions from processor 46. Speaker 40B outputs audio according to instructions from processor 46. Camera 42 is a compact digital camera equipped with an optical system including a lens, aperture, and shutter, and an imaging element such as a CMOS (Complementary Metal-Oxide-Semiconductor) image sensor or a CCD (Charge Coupled Device) image sensor.

The communication interface 44 is connected to the network 54. The communication interfaces 44 and 26 manage the exchange of various information between processor 46 and processor 28 via network 54.

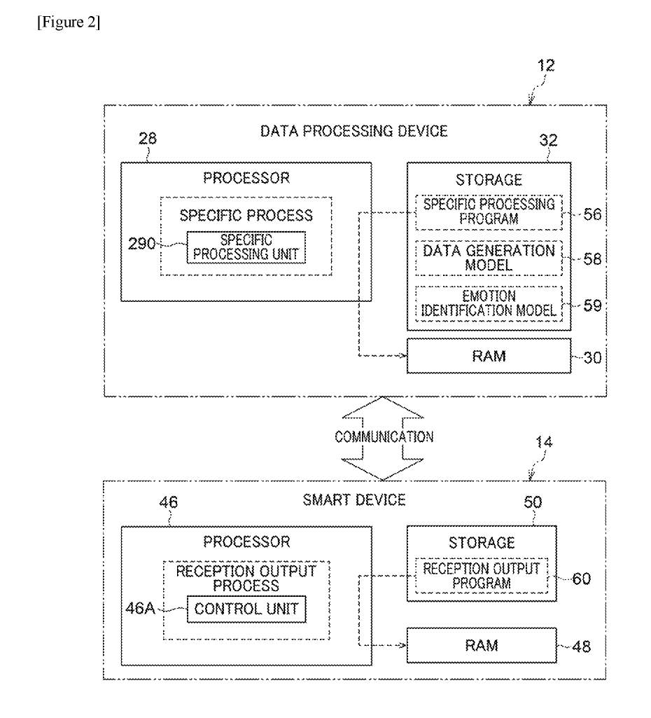

FIG. 2 shows an example of the main functions of the data processing device 12 and the smart device 14.

As shown in FIG. 2, specific processing is performed by processor 28 in data processing device 12. Specific processing program 56 is stored in storage 32. Specific processing program 56 is an example of a "program" related to the technology of this disclosure. Processor 28 reads specific processing program 56 from storage 32 and executes the read specific processing program 56 on RAM 30. Specific processing is realized by processor 28 operating as specific processing unit 290 according to specific processing program 56 executed on RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by specific processing unit 290. Specific processing unit 290 can estimate a user's emotion using emotion identification model 59 and perform specific processing using the user's emotion. The emotion estimation function (emotion identification function) using the emotion identification model 59 performs various estimations and predictions concerning the user's emotion, including estimation and prediction of the user's emotion, but is not limited to such examples. Furthermore, estimation and prediction of emotion also includes, for example, analysis (parsing) of emotion.

The smart device 14 performs reception output processing via the processor 46. The reception output program 60 is stored in the storage 50. The reception output program 60 is used in conjunction with the specific processing program 56 by the data processing system 10. The processor 46 reads the reception output program 60 from the storage 50 and executes the read reception output program 60 on the RAM 48. The specific processing is performed by the processor 46 operating as a control unit 46A according to the specific processing program 60 executed on the RAM 48. Note that the smart device 14 may also have data generation models and emotion identification models similar to the data generation model 58 and emotion identification model 59, and may perform processing similar to that of the specific processing unit 290 using these models. The reception output processing is realized by the processor 46 operating as the control unit 46A according to the reception output program 60 executed on the RAM 48.

Other devices besides the data processing device 12 may also have the data generation model 58. For example, a server device (e.g., a generation server) may have the data generation model 58. In this case, the data processing device 12 communicates with the server device having the data generation model 58 to obtain processing results (such as prediction results) obtained using the data generation model 58. Furthermore, the data processing device 12 may be the server device itself, or it may be a terminal device owned by a user (e.g., a mobile phone, robot, home appliance, etc.). Next, an example of processing by the data processing system 10 according to the first embodiment will be described.

### Example 1

The flow of the specific processing in Example 1 is described below. The components of the system described below are implemented by the data processing device 12 and the smart device 14. The data processing device 12 is referred to as the "server," and the smart device 14 is referred to as the "terminal."

### Implementation Examples for Carrying Out the Invention

The embodiment for implementing the present invention will now be described in further detail. This system is realized using a server and a terminal, and the functions of each component will be clarified.

First, the input unit that receives user input is implemented on the terminal. The terminal is a device such as a smartphone, tablet, or personal computer. The user employs these devices to input desired room styles, color tones, atmospheres, etc., through a chat-based interface. For example, if the user inputs "I want a room with a modern style, warm color tones, and a relaxing atmosphere," the system receives this input and analyzes it using natural language processing technology. This analysis includes tokenizing the user's input, extracting keywords and cross-referencing them with databases related to style and color schemes.

Next, the data acquisition unit, implemented on both the terminal and the server, obtains real-world environmental data of the target room. The terminal acquires 3D scan data of the room using a device equipped with LiDAR technology. For example, it uses a LiDAR sensor built into a smartphone to scan the room's dimensions and shape, acquiring the data. This scan data contains detailed information such as the position of the room's walls, ceiling height, and the location of windows and doors. Additionally, the terminal captures images or videos of the room using its camera and transmits this data to the server. The server analyzes the received data to understand the room's physical constraints. For example, it uses image analysis technology to identify existing furniture and decorative items in the room and takes their placement into account.

The layout generation unit, which uses generative AI to create room layouts, is primarily implemented on the server. The server integrates the user's preferences with the actual environment data and generates the optimal room layout based on various room layout data learned in the past. This process involves data analysis using machine learning algorithms, referencing past examples closest to the user's desired style, and considering furniture placement that fits the room dimensions. For example, when proposing the placement of a sofa, table, and lighting fixtures in a modern-style living room, it generates a design aligned with the user's preferences while considering furniture arrangements that fit the room's dimensions.

The proposal unit, which suggests specific furniture and appliances based on the generated layout, is implemented on the server. The server selects actual furniture and appliances sold by manufacturers based on the generated layout. For example, if the proposed sofa is a specific model number from a particular manufacturer, the server presents that product information to the user. At this point, the server references online catalogs for furniture and appliances, providing detailed information such as price, size, color, and material. It is also possible to provide links and information for purchasing the furniture or appliances selected by the user. For example, if a user wishes to purchase the proposed sofa, the server provides a link to the online store selling that sofa and supports the purchase process.

Furthermore, the function for proposing product and shelf placement methods within commercial facilities is implemented on the server. The server uses algorithms based on behavioral economics to propose optimal product placements that encourage customer purchasing behavior. For example, it suggests placements that promote cross-selling, such as placing best-selling items in prominent locations or placing related items nearby. This process involves data mining techniques that analyze store layout data, customer movement data, and historical sales data to derive the most effective placements.

Thus, the present invention is realized by combining a server and terminals, enabling the rapid provision of practical and effective layout proposals tailored to user preferences. This facilitates time and cost savings, improved customer satisfaction, and increased sales for both individuals and businesses.

### System Configuration

The system according to this embodiment comprises an input unit, a data acquisition unit, a layout generation unit, and a proposal unit. The input unit receives information such as the desired room style, color scheme, and atmosphere from the user. Specifically, the user inputs this information via a chat-based interface using terminals such as smartphones, tablets, or PCs. For example, when a user inputs "I want a bright room with a simple Scandinavian design that makes the most of natural light," the system receives this information and analyzes it using natural language processing technology. This analysis involves tokenizing the input text, extracting keywords, and cross-referencing them with databases related to styles and color schemes. Furthermore, the user can also input specific preferences regarding furniture types and placement, such as detailed requests like "I want to place a reading chair near the large window."

The data acquisition unit possesses the function of acquiring real-world environmental data of the target room. This unit is implemented on both the terminal and the server, acquiring 3D scan data of the room using devices equipped with LiDAR technology. For example, it scans the room's dimensions and shape using a LiDAR sensor mounted on a smartphone to acquire data. This scan data contains detailed information such as the position of the room's walls, ceiling height, and the location of windows and doors. Additionally, it captures images and videos of the room using the terminal's camera and transmits this data to the server. The server analyzes the received data to understand the room's physical constraints. For example, it can use image analysis technology to identify existing furniture and decorations in the room and factor their placement into the analysis. Furthermore, it can analyze the room's lighting conditions and color tones and reflect them in the proposed layout.

The layout generation unit possesses the function of generating room layouts using generative AI. This unit is primarily implemented on the server. It integrates the user's preferences with the actual environment data and generates the optimal room layout based on various room layout data learned in the past. Specifically, this involves data analysis using machine learning algorithms, referencing past cases closest to the user's desired style, and considering furniture placement suited to the room's dimensions. For example, when proposing the placement of a sofa, table, and lighting fixtures in a modern-style living room, it generates a design aligned with the user's preferences while considering furniture arrangements that fit the room's dimensions. Specific examples of prompt text fed to the generative AI include instructions such as: "Propose an arrangement that maximizes natural light, based on a bright color scheme, in a Scandinavian style as desired by the user."

The proposal section possesses the functionality to suggest specific furniture and appliances based on the generated layout. This section is implemented on the server, selecting actual furniture and appliances sold by manufacturers based on the generated layout. For example, if the proposed sofa is a specific model number from a particular manufacturer, the server presents that product information to the user. At this point, the server references online catalogs for furniture and appliances, providing detailed information such as price, size, color, and material. It can also provide links and information for purchasing the furniture or appliances selected by the user. For instance, if a user wishes to purchase the proposed sofa, the server provides a link to the online store selling that sofa and supports the purchase process. Furthermore, it includes a function to propose product and shelf placement methods within commercial facilities. Using algorithms based on behavioral economics, it suggests optimal product placement to encourage customer purchasing behavior. For instance, it suggests placements that promote cross-selling, such as placing best-selling items in prominent locations or placing related items nearby. This process involves data mining techniques that analyze store layout data, customer traffic flow data, and historical sales data to derive the most effective placement.

Thus, the system according to this embodiment can rapidly provide practical and effective layout proposals tailored to user preferences. This enables both individuals and businesses to reduce time and costs, enhance customer satisfaction, and increase sales.

### Implementation Steps

### Step 1: Accepting User Input

The user inputs information about their desired room style, color scheme, atmosphere, etc., via a chat-based interface using a terminal such as a smartphone, tablet, or PC. For example, if the user inputs "I want a bright room with a simple Scandinavian design that makes the most of natural light," the system receives this information and analyzes it using natural language processing technology. This analysis involves tokenizing the input text, extracting keywords, and matching them against databases related to style and color scheme. Furthermore, users can input specific preferences regarding furniture types and placement, such as detailed requests like "I want to place a reading chair near the large window."

### Step 2: Acquisition of Real-Environment Data

The data acquisition component is implemented on both the terminal and the server. It acquires 3D scan data of the room using devices equipped with LiDAR technology. For example, it scans the room's dimensions and shape using a LiDAR sensor built into a smartphone to obtain the data. This scan data contains detailed information such as the position of the room's walls, ceiling height, and the location of windows and doors. Additionally, the terminal's camera captures images or videos of the room, and this data is transmitted to the server. The server analyzes the received data to understand the room's physical constraints. For example, image analysis technology can identify existing furniture or decorations in the room and factor their placement into the analysis. Furthermore, the server can analyze the room's lighting conditions and color tones and incorporate them into the proposed layout.

### Step 3: Layout Generation

The layout generation unit possesses the function of generating room layouts using generative AI. This unit is primarily implemented on the server. It integrates the user's preferences with the actual environment data and generates the optimal room layout based on various room layout data learned in the past. Specifically, this involves data analysis using machine learning algorithms, referencing past cases closest to the user's desired style, and considering furniture placement suited to the room's dimensions. Examples of prompt sentences fed to the generative AI include instructions such as: "Propose a layout utilizing natural light to the maximum extent, based on a bright color scheme, in the Nordic style preferred by the user."

### Step 4: Proposing Specific Furniture and Appliances

The proposal section possesses the functionality to suggest specific furniture and appliances based on the generated layout. This section is implemented on the server, selecting actual furniture and appliances sold by manufacturers based on the generated layout. For example, if the proposed sofa is a specific model number from a particular manufacturer, the server presents that product information to the user. At this point, the server references online catalogs for furniture and appliances, providing detailed information such as price, size, color, and material. It can also provide links and information for purchasing the furniture or appliances selected by the user. For instance, if a user wishes to purchase the proposed sofa, the server provides a link to the online store selling that sofa and supports the purchase process. Furthermore, it includes a function to propose product and shelf placement methods within commercial facilities. Using algorithms based on behavioral economics, it suggests optimal product placement to encourage customer purchasing behavior. For instance, it suggests placements that promote cross-selling, such as placing best-selling items in prominent locations or placing related items nearby. This process involves data mining techniques that analyze store layout data, customer traffic flow data, and historical sales data to derive the most effective placement.

### Specific Use Cases

For example, consider a user who wants to design a new living room layout. This user accesses the system via smartphone and inputs their desired room style, color scheme, and atmosphere through a chat-based interface. The user inputs, "I want a living room with a modern, simple design, calm color tones, and a relaxing atmosphere." This information is analyzed using natural language processing technology and used as data to understand the user's preferences concretely.

Next, the user performs a 3D scan of the living room using the LiDAR sensor built into their smartphone. This scan data includes detailed information such as room dimensions, wall positions, ceiling height, and the locations of windows and doors. Additionally, the user takes images and videos of the room using the smartphone's camera and sends this data to the server. The server analyzes the received data to understand the room's physical constraints. For example, it can take into account the existing furniture layout and the room's lighting conditions.

Generative AI integrates the user's preferences with the real-world environmental data to generate an optimal living room layout. Specific examples of prompt text fed to the generative AI include instructions such as: "Propose a living room layout featuring a modern, simple style with a calm color scheme and a relaxing atmosphere, based on the user's preferences." The generative AI generates the design closest to the user's preferences based on various living room layout data learned in the past.

Based on the generated layout, the proposal unit suggests specific furniture and appliances. For example, if the proposed sofa is a specific model from a particular manufacturer, the server presents the product information to the user. At this stage, the server references online catalogs for furniture and appliances, providing detailed information such as price, size, color, and material. It is also possible to provide links and information for purchasing the furniture or appliances selected by the user. For example, if the user wishes to purchase the proposed sofa, the server provides a link to an online store selling that sofa and supports the purchase process.

In this way, users can quickly obtain a living room layout matching their desired style and actual environment, receiving consistent support from selecting specific furniture and appliances through to purchase. This system allows customization according to user needs and can provide practical and effective layout proposals.

### Application Example 1

The flow of the specific processing in Application Example 1 is described below. The components of the system described below are implemented by the data processing device 12 and the smart device 14. The data processing device 12 is referred to as the "server," and the smart device 14 is referred to as the "terminal."

### Implementation Examples for the Present Invention

The embodiment for implementing the present invention is described in further detail below. This system is designed to optimize the placement of products in physical stores and includes a data input unit, an environmental data acquisition unit, a layout generation unit, and a proposal unit.

First, the data input unit has the function of receiving information from store managers. Specifically, data such as product type, size, price, inventory status, and past sales data is input. For example, if sales of a specific product surge during a particular period, that data is also input. Additionally, seasonal sales trends and sales data during specific campaign periods are included. Furthermore, data regarding product display methods and the effectiveness of promotions may also be input. This enables the system to accurately grasp product demand and obtain foundational data for proposing optimal placement.

Next, the environmental data acquisition unit performs a 3D scan of the store using LiDAR technology to understand the physical layout. This scan acquires detailed physical data such as store dimensions, aisle widths, shelf heights, and product placements. For example, it can accurately determine customer flow paths from the store entrance to the register and precisely identify which products are placed around specific items. Furthermore, the lighting conditions within the store and the congestion levels based on customer movement patterns are also analyzed. This enables an understanding of how customers move within the store, allowing for the proposal of optimal product placement. Additionally, the design of the store's exterior and interior can be taken into account, and data to enhance the customer's visual experience is also acquired.

The layout generation unit utilizes generative AI to generate optimal store layouts. This unit analyzes historical sales data and customer movement patterns to generate product placements that maximize sales. For example, placing popular items in highly visible locations increases customer purchase intent. It also proposes layouts that promote cross-selling by placing related products nearby. For instance, placing snacks near beverages increases the likelihood customers will purchase both items. Furthermore, placing seasonal or promotional items in prominent locations can boost sales. The generative AI uses algorithms based on this data to predict customer purchasing behavior and derive the most effective placement.

The proposal unit possesses the function of suggesting specific product placements based on the generated layout. Store managers can review the proposed layout and make adjustments as needed. For example, if a particular product is seasonal, they can adjust the placement to position it in a prominent location. Furthermore, the proposal unit simulates the actual impact of the proposed layout on sales and provides predictive results. This simulation models customer purchasing behavior to forecast how different layouts will affect sales. For example, it predicts sales for the month following the introduction of a new layout and presents this to the manager. Additionally, the proposal unit can provide information on product replenishment and inventory management to support efficient store operations.

Thus, the present invention can optimize product placement in physical stores, enhance customer purchasing motivation, and increase sales. It also enables the reduction of time and cost associated with store layout changes, achieving efficient operations. Consequently, stores can maintain competitiveness and improve customer satisfaction.

### System Configuration

The system according to this embodiment comprises a data input unit, an environmental data acquisition unit, a layout generation unit, and a proposal unit. The data input unit has the function of receiving information from store managers. Specifically, information such as product type, size, price, inventory status, and past sales data is input. For example, if sales of a specific product surge during a particular period, that data is also input. It also includes seasonal sales trends and sales data from specific campaign periods. Furthermore, data regarding product display methods and the effectiveness of promotions may also be input. This enables the system to accurately grasp product demand and obtain foundational data for proposing optimal placements.

The environmental data acquisition unit uses LiDAR technology. This scan acquires detailed physical data such as store dimensions, aisle widths, shelf heights, and product placements. For example, it can precisely map customer flow paths from the store entrance to the register and identify which products are placed around specific items. Furthermore, the lighting conditions within the store and the congestion levels based on customer flow patterns are also analyzed. This enables an understanding of how customers move within the store and allows for the proposal of optimal product placement. Additionally, the design of the store's exterior and interior can be taken into account, and data to enhance the customer's visual experience is also acquired.

The layout generation unit utilizes generative AI to generate optimal store layouts. This unit analyzes historical sales data and customer flow data to generate product placements that maximize sales. For example, placing popular items in highly visible locations increases customer purchase intent. It also proposes layouts that promote cross-selling by placing related products nearby. For instance, placing snacks near beverages increases the likelihood customers will purchase both items. Furthermore, placing seasonal or promotional items in prominent locations can boost sales. Generative AI uses algorithms based on this data to predict customer purchasing behavior and derive the most effective layouts. Specific examples of prompts fed to the generative AI include instructions such as: "Place best-selling items in prominent locations and position related products nearby to promote cross-selling."

The proposal unit possesses the function of suggesting specific product placements based on the generated layout. Store managers can review the proposed layout and make adjustments as needed. For example, if a particular product is seasonal, they can adjust the placement to position it in a prominent location. Furthermore, the proposal unit simulates the actual impact of the proposed placement on sales and provides forecast results. This simulation models customer purchasing behavior to predict how different layouts will affect sales. For example, it forecasts sales for the month following the introduction of a new layout and presents this to the manager. Additionally, the proposal unit can provide information on product replenishment and inventory management to support efficient store operations.

Thus, the system according to this embodiment can optimize product placement in physical stores, enhance customer purchasing motivation, and increase sales. It also reduces the time and cost associated with store layout changes, enabling efficient operations. This allows stores to maintain competitiveness and improve customer satisfaction.

### Implementation Steps

### Step 1: Data Input

The data input unit receives information from store managers. Specifically, data such as product type, size, price, inventory status, and historical sales data is entered. For example, if sales of a specific product surge during a particular period, that data is also entered. It also includes seasonal sales trends and sales data from specific campaign periods. Furthermore, data regarding product display methods and the effectiveness of promotions may also be entered. This enables the system to accurately grasp product demand and obtain foundational data for proposing optimal placement.

### Step 2: Acquisition of Environmental Data

The environmental data acquisition unit performs a 3D scan of the store using LiDAR technology to understand the physical layout. This scan captures detailed physical data such as store dimensions, aisle widths, shelf heights, and product placements. For example, it can precisely map customer movement paths from the store entrance to the register. It also analyzes lighting conditions within the store and congestion levels based on customer flow patterns. This enables understanding of how customers move within the store, facilitating the proposal of optimal product placements. Furthermore, it can incorporate the store's exterior and interior design, acquiring data to enhance the customer's visual experience.

### Step 3: Layout Generation

The layout generation unit uses generative AI to create the optimal store layout. This unit analyzes historical sales data and customer movement patterns to generate product placements that maximize sales. For example, placing popular items in highly visible locations increases customer purchase intent. It also proposes layouts that promote cross-selling by placing related products nearby. For instance, placing snacks near beverages increases the likelihood customers will purchase both items. Furthermore, placing seasonal or promotional items in prominent locations can boost sales. Specific examples of prompt text fed to the generative AI include instructions such as: "Place best-selling items in prominent locations and position related products nearby to promote cross-selling."

### Step 4: Proposal and Simulation

The Proposal Department proposes specific product placements based on the generated layouts. Store managers can review the proposed placements and make adjustments as needed. For example, if a particular product is seasonal, they can adjust its placement to a more prominent location. Additionally, the Proposal Department simulates the actual impact of the proposed placement on sales and provides forecast results. This simulation models customer purchasing behavior to predict how different layouts will affect sales. For example, it forecasts sales for the month following the introduction of a new layout and presents this to the manager. Furthermore, the Proposal Department can also provide information on product replenishment and inventory management to support efficient store operations.

### Specific Use Cases

For example, a retail store wishes to optimize its in-store layout following the introduction of new products. This store aims to maximize sales and enhance the customer shopping experience by effectively positioning best-selling items and new products. The store manager accesses the system and inputs data through the data input section, including product type, size, price, inventory status, and historical sales data. For example, they might input data showing that a specific beverage experiences a sharp increase in sales during summer or that a particular snack is popular during promotional periods.

Next, the environmental data acquisition unit performs a 3D scan of the store. This scan captures detailed physical data such as store dimensions, aisle widths, shelf heights, and product placements. For instance, it accurately maps customer flow paths from the store entrance to the register and identifies which products surround specific items. Additionally, the lighting conditions within the store and the congestion levels based on customer flow paths are analyzed. This enables an understanding of how customers move within the store and allows for the proposal of optimal product placement.

The layout generation unit uses generative AI to generate the optimal store layout. Specific examples of prompt text fed to the generative AI include instructions such as: "Place summer best-selling beverages in prominent positions and position related snack foods nearby to promote cross-selling." The generative AI analyzes historical sales data and customer movement patterns to generate product placements that maximize revenue. For example, placing snacks near beverages increases the likelihood customers will purchase both items. Additionally, placing seasonal items or campaign products in prominent locations can boost sales.

The proposal unit suggests specific product placements based on the generated layout. Store managers can review the proposed layout and make adjustments as needed. For example, if a specific product is seasonal, they can adjust to place it in a prominent location. Furthermore, the proposal department simulates the actual impact of the proposed placement on sales and provides forecast results. This simulation models customer purchasing behavior to predict how different layouts affect sales. For example, it forecasts sales for the month following the introduction of a new layout and presents this to the manager. Additionally, the proposal department can provide information on product replenishment and inventory management to support efficient store operations.

In this way, stores can enhance customer purchasing motivation and increase sales. Furthermore, it becomes possible to reduce the time and cost associated with store layout changes and achieve efficient operations. This enables stores to maintain competitiveness and improve customer satisfaction.

The specific processing unit 290 transmits the results of the specific processing to the smart device 14. On the smart device 14, the control unit 46A instructs the output device 40 to output the results of the specific processing. The microphone 38B acquires audio indicating user input regarding the results of the specific processing. The control unit 46A transmits the audio data indicating the user input acquired by the microphone 38B to the data processing unit 12. At the data processing unit 12, the specific processing unit 290 acquires the audio data.

The data generation model 58 is a so-called generative AI (Artificial Intelligence). An example of the data generation model 58is ChatGPT (registered trademark) (Internet search <URL: https://openai.com/blog/chatgpt>). The data generation model 58 is obtained by performing deep learning on a neural network. The data generation model 58 receives input of a prompt containing instructions, as well as inference data such as audio data representing sound, text data representing text, and image data (e.g., still image data or video data) representing images. The data generation model 58 infers based on the input inference data according to the instructions indicated by the prompt and outputs the inference result in one or more data formats, such as audio data, text data, and image data. The data generation model 58 includes, for example, text generation AI, image generation AI, and multimodal generation AI. Here, inference refers to, for example, analysis, classification, prediction, and/or summarization. The specific processing unit 290 performs the aforementioned specific processing while utilizing the data generation model 58. The data generation model 58 may be a fine-tuned model capable of outputting inference results from prompts that do not contain instructions. In this case, the data generation model 58 can output inference results from prompts that do not contain instructions. The data processing device 12 and the like may include multiple types of data generation models 58. The data generation model 58 includes AI other than generative AI. AI other than generative AI includes, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others. The AI may perform various processing operations, but is not limited to such examples. The AI may also be an AI agent. Furthermore, when the processing of the aforementioned components is performed by the AI, such processing may be performed in part or in whole by the AI, but is not limited to such examples. Furthermore, processing performed by AI, including generative AI, may be replaced by rule-based processing, and rule-based processing may be replaced by processing performed by AI, including generative AI.

Furthermore, the processing performed by the data processing system 10 described above is executed by either the specific processing unit 290 of the data processing device 12 or the control unit 46A of the smart device 14, but it may also be executed by both the specific processing unit 290 of the data processing device 12 and the control unit 46A of the smart device 14. Furthermore, the specific processing unit 290 of the data processing device 12 acquires or collects information necessary for processing from the smart device 14 or external devices, etc., and the smart device 14 acquires or collects information necessary for processing from the data processing device 12 or external devices, etc.

For example, the collection unit may be implemented by the control unit 46A of the smart device 14 or the specific processing unit 290 of the data processing device 12. For example, the acquisition unit acquires step count data using the camera 42 or communication I/F 44 of the smart device 14, and this data is processed by the specific processing unit 290 of the data processing device 12. For example, the analysis unit is implemented by the specific processing unit 290 of the data processing device 12 and analyzes data from the collection unit and acquisition unit. For example, the generation unit is implemented by the specific processing unit 290 of the data processing device 12 and generates a cooking menu using a generation AI. For example, the provision unit is implemented by the output device 40 of the smart device 14 or the specific processing unit 290 of the data processing device 12 and provides the generated cooking menu to the user. The correspondence between each unit and the device or control unit is not limited to the above examples and various modifications are possible.

The above embodiment described a form where specific processing is performed by the data processing device 12, but the technology disclosed herein is not limited thereto; specific processing may also be performed by the smart device 14.

### Second Embodiment

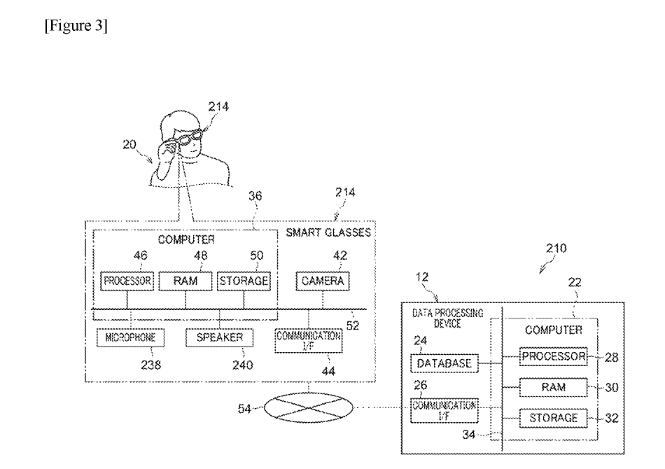

FIG. 3 shows an example configuration of the data processing system 210 according to the second embodiment.

As shown in FIG. 3, the data processing system 210 includes a data processing device 12 and smart glasses 214. An example of the data processing device 12 is a server.

The data processing device 12 includes a computer 22, a database 24, and a communication I/F 26. The computer 22 is an example of a "computer" according to the technology of the present disclosure. The computer 22 includes a processor 28, RAM 30, and storage 32. The processor 28, RAM 30, and storage 32 are connected to a bus 34. The database 24 and communication I/F 26 are also connected to the bus 34. The communication I/F 26 is connected to a network 54. An example of the network 54 include a WAN (Wide Area Network) and/or a LAN (Local Area Network).

The smart glasses 214 include a computer 36, a microphone 238, a speaker 240, a camera 42, and a communication I/F 44. The computer 36 includes a processor 46, RAM 48, and storage 50. Processor 46, RAM 48, and storage 50 are connected to bus 52. Microphone 238, speaker 240, and camera 42 are also connected to bus 52.

Microphone 238 receives voice input from user 20, thereby accepting instructions or other input from user 20. Microphone 238 captures the voice input from user 20 and converts the captured audio into audio data, which it outputs to the processor 46. The speaker 240 outputs audio in accordance with instructions from the processor 46.

The camera 42 is a compact digital camera equipped with an optical system, such as a lens, aperture, and shutter, and an imaging element, such as a CMOS (Complementary Metal-Oxide-Semiconductor) image sensor or a CCD (Charge Coupled Device) image sensor. It captures images of the user's surroundings (e.g., within a field of view equivalent to that of a typical healthy individual).

The communication I/F 44 is connected to the network 54. The communication I/Fs 44 and 26 manage the exchange of various information between processor 46 and processor 28 via network 54. The exchange of various information between processor 46 and processor 28 using communication I/F 44 and 26 is performed in a secure state.

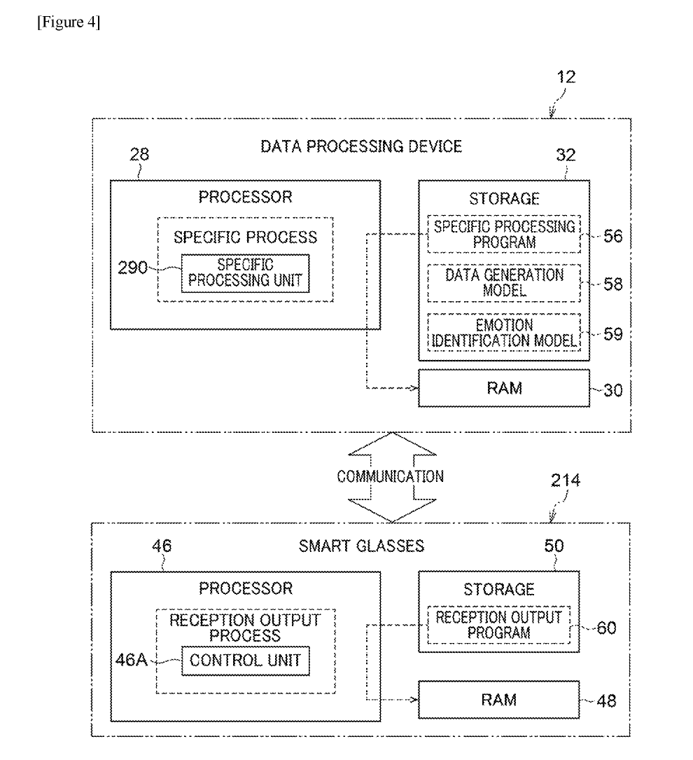

FIG. 4 shows an example of the main functions of the data processing device 12 and the smart glasses 214. As shown in FIG. 4, specific processing is performed by the processor 28 in the data processing device 12. The specific processing program 56 is stored in the storage 32.

The specific processing program 56 is an example of a "program" pertaining to the technology of this disclosure. The processor 28 reads the specific processing program 56 from the storage 32 and executes the read specific processing program 56 on the RAM 30. The specific processing is realized by the processor 28 operating as the specific processing unit 290 according to the specific processing program 56 executed on the RAM 30.

The storage 32 stores a data generation model 58 and an emotion identification model 59. The data generation model 58 and emotion identification model 59 are used by specific processing unit 290. Specific processing unit 290 can estimate a user's emotion using emotion identification model 59 and perform specific processing using the user's emotion. The emotion estimation function (emotion identification function) using the emotion identification model 59 performs various estimations and predictions concerning the user's emotion, including estimation and prediction of the user's emotion, but is not limited to such examples. Furthermore, estimation and prediction of emotion also includes, for example, analysis (parsing) of emotion.

In the smart glasses 214, the processor 46 performs the reception output processing. The reception output program 60 is stored in the storage 50. The processor 46 reads the reception output program 60 from the storage 50 and executes the read reception output program 60 on the RAM 48. The reception output processing is realized by the processor 46 operating as the control unit 46A according to the reception output program 60 executed on the RAM 48. The reception output processing is performed by the processor 46 acting as a control unit 46A according to the reception output program 60 executed on RAM 48. Note that the smart glasses 214 may also have a data generation model 58 and an emotion identification model 59, and can perform processing similar to that of the identification processing unit 290 using these models.

Next, the identification processing performed by the identification processing unit 290 of the data processing device 12 is described. The components of the system described below are implemented by the data processing device 12 and the smart glasses 214. In the following description, the data processing device 12 is referred to as the "server," and the smart glasses 214 are referred to as the "terminal."

### Example 1

The flow of the specific processing in Example 1 described in the first embodiment is the same as described above, so the explanation is omitted.

### Application Example 1

The flow of the specific processing in Example 1 described in the first embodiment is the same as above, so the explanation is omitted.

The specific processing unit 290 transmits the result of the specific processing to the smart glasses 214. In the smart glasses 214, the control unit 46A causes the speaker 240 to output the result of the specific processing. The microphone 238 acquires audio indicating user input regarding the result of the specific processing. The control unit 46A transmits the audio data indicating the user input acquired by the microphone 238 to the data processing device 12. At the data processing device 12, the specific processing unit 290 acquires the audio data.

The data generation model 58 is a so-called generative AI (Artificial Intelligence). An example of the data generation model 58 is ChatGPT (registered trademark) (Internet search <URL: https://openai.com/blog/chatgpt>). The data generation model 58 is obtained by performing deep learning on a neural network. The data generation model 58 receives input prompts containing instructions, as well as inference data such as audio data representing sound, text data representing text, and image data (e.g., still image data or video data) representing images. The data generation model 58 infers based on the input inference data according to the instructions indicated by the prompt and outputs the inference result in one or more data formats, such as audio data, text data, and image data. The data generation model 58 includes, for example, text generation AI, image generation AI, and multimodal generation AI. Here, inference refers to, for example, analysis, classification, prediction, and/or summarization. The specific processing unit 290 performs the aforementioned specific processing while utilizing the data generation model 58. The data generation model 58 may be a fine-tuned model capable of outputting inference results from prompts that do not contain instructions. In this case, the data generation model 58 can output inference results from prompts that do not contain instructions. The data processing device 12 and the like may include multiple types of data generation models 58. The data generation model 58 includes AI other than generative AI. AI other than generative AI includes, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others. The AI may perform various processing operations, but is not limited to such examples. The AI may also be an AI agent. Furthermore, when the processing of the aforementioned components is performed by the AI, such processing may be performed in part or in whole by the AI, but is not limited to such examples. Furthermore, processing performed by AI, including generative AI, may be replaced by rule-based processing, and rule-based processing may be replaced by processing performed by AI, including generative AI.

Furthermore, the processing performed by the data processing system 10 described above is executed by either the specific processing unit 290 of the data processing device 12 or the control unit 46A of the smart device 14, but it may also be executed by both the specific processing unit 290 of the data processing device 12 and the control unit 46A of the smart device 14. Furthermore, the specific processing unit 290 of the data processing device 12 acquires or collects information necessary for processing from the smart device 14 or external devices, etc., and the smart device 14 acquires or collects information necessary for processing from the data processing device 12 or external devices, etc.

For example, the collection unit may be implemented by the control unit 46A of the smart device 14 or the specific processing unit 290 of the data processing device 12. For example, the acquisition unit may acquire step count data using the camera 42 or communication I/F 44 of the smart device 14, and the acquisition unit and collection unit may process the data acquired by the acquisition unit. processing unit 290 of the data processing device 12. For example, the analysis unit is implemented by the specific processing unit 290 of the data processing device 12 and analyzes data from the collection unit and acquisition unit. For example, the generation unit is implemented by the specific processing unit 290 of the data processing device 12 and generates a cooking menu using a generation AI. For example, the provision unit is implemented by the output device 40 of the smart device 14 or the specific processing unit 290 of the data processing device 12 and provides the generated cooking menu to the user. The correspondence between each unit and the device or control unit is not limited to the above examples and various modifications are possible.

The above embodiment described a form where specific processing is performed by the data processing device 12, but the technology disclosed herein is not limited thereto; specific processing may also be performed by the smart glasses 214.

### Third Embodiment

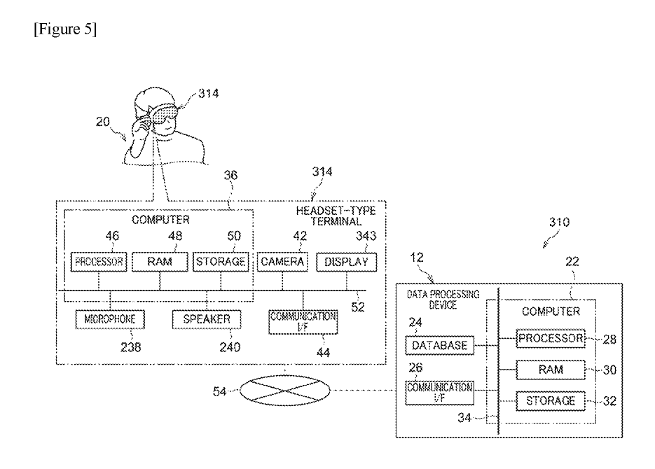

FIG. 5 shows an example configuration of the data processing system 310 according to the third embodiment.

As shown in FIG. 5, the data processing system 310 includes a data processing device 12 and a headset-type terminal 314. An example of the data processing device 12 is a server.

The data processing device 12 includes a computer 22, a database 24, and a communication I/F 26. The computer 22 is an example of a "computer" according to the technology of the present disclosure. The computer 22 includes a processor 28, RAM 30, and storage 32. The processor 28, RAM 30, and storage 32 are connected to a bus 34. The database 24 and communication I/F 26 are also connected to the bus 34. The communication I/F 26 is connected to a network 54. An example of the network 54 include a WAN (Wide Area Network) and/or a LAN (Local Area Network).

The headset-type terminal 314 includes a computer 36, a microphone 238, a speaker 240, a camera 42, a communication interface 44, and a display 343. The computer 36 includes a processor 46, RAM 48, and storage 50. The processor 46, RAM 48, and storage 50 are connected to a bus 52. The microphone 238, speaker 240, camera 42, and display 343 are also connected to the bus 52.

Microphone 238 receives voice input from user 20 to accept instructions or other commands. Microphone 238 captures the voice input from user 20, converts the captured voice into audio data, and outputs it to processor 46. Speaker 240 outputs audio in accordance with instructions from processor 46.

Camera 42 is a compact digital camera equipped with an optical system, such as a lens, aperture, and shutter, and an imaging element, such as a CMOS (Complementary Metal-Oxide-Semiconductor) image sensor or a CCD (Charge Coupled Device) image sensor. It captures images of the user's surroundings (e.g., an imaging range defined by a field of view equivalent to that of a typical healthy person).

The communication I/F 44 is connected to the network 54. The communication I/Fs 44 and 26 handle the exchange of various information between processor 46 and processor 28 via network 54. The exchange of various information between processor 46 and processor 28 using communication I/F 44 and 26 is performed in a secure state.

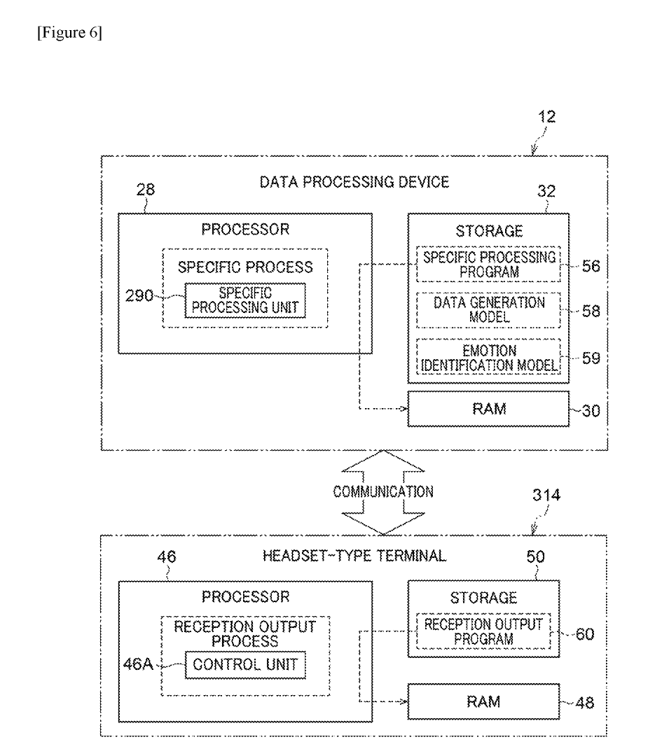

FIG. 6 illustrates an example of key functions of the data processing device 12 and the headset-type terminal 314. As shown in FIG. 6, specific processing is performed by the processor 28 within the data processing device 12. The specific processing program 56 is stored in the storage 32.

The specific processing program 56 is an example of a "program" related to the technology of the present disclosure. The processor 28 reads the specific processing program 56 from the storage 32 and executes the read specific processing program 56 on the RAM 30. The specific processing is realized by the processor 28 operating as the specific processing unit 290 according to the specific processing program 56 executed on the RAM 30.

The storage 32 stores a data generation model 58 and an emotion identification model 59. The data generation model 58 and the emotion identification model 59 are used by the specific processing unit 290.

In the headset-type terminal 314, reception output processing is performed by the processor 46. The reception output program 60 is stored in the storage 50. Processor 46 reads the reception output program 60 from storage 50 and executes the read reception output program 60 on RAM 48. Reception output processing is achieved by processor 46 operating as control unit 46A according to the reception output program 60 executed on RAM 48.

Next, the specific processing performed by the specific processing unit 290 of the data processing device 12 is described. The various parts of the system described below are implemented by the data processing device 12 and the headset-type terminal 314. In the following description, the data processing device 12 is referred to as the "server," and the headset-type terminal 314 is referred to as the "terminal."

### Example 1

The flow of the specific processing is the same as that described in Example 1 of the first embodiment, so the description is omitted.

### Application Example 1

The flow of the specific processing in Example 1 described in the first embodiment is the same as above, so the explanation is omitted.

The specific processing unit 290 transmits the result of the specific processing to the headset-type terminal 314. At the headset-type terminal 314, the control unit 46A causes the speaker 240 and the display 343 to output the result of the specific processing. The microphone 238 acquires audio indicating user input regarding the result of the specific processing. The control unit 46A transmits the audio data indicating the user input acquired by the microphone 238 to the data processing device 12. At the data processing device 12, the specific processing unit 290 acquires the audio data.

The data generation model 58 is a so-called generative AI (Artificial Intelligence). An example of the data generation model 58 is ChatGPT (registered trademark) (Internet search <URL: https://openai.com/blog/chatgpt>). The data generation model 58 is obtained by performing deep learning on a neural network. A prompt containing instructions is input to the data generation model 58, and inference data such as audio data (e.g., data of still images or data of videos) is input. The data generation model 58 infers based on the input inference data according to the instructions indicated by the prompt and outputs the inference result in one or more data formats such as audio data, text data, and image data. The data generation model 58 may include, for example, text generation AI, image generation AI, multimodal generation AI, etc. Here, inference refers to, for example, analysis, classification, prediction, and/or summarization. The specific processing unit 290 performs the specific processing described above using the data generation model 58. The data generation model 58 may be a fine-tuned model capable of outputting inference results from prompts that do not contain instructions. In this case, the data generation model 58 can output inference results from prompts that do not contain instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others. The AI may perform various processing operations, but are not limited to these examples. Furthermore, the AI may be an AI agent. Also, when the processing of the aforementioned components is performed by AI, that processing may be performed in part or in whole by AI, but is not limited to such examples. Furthermore, processing performed by AI, including generative AI, may be replaced by rule-based processing, and rule-based processing may be replaced by processing performed by AI, including generative AI.

Furthermore, the processing performed by the data processing system 10 described above is executed by either the specific processing unit 290 of the data processing device 12 or the control unit 46A of the smart device 14, but it may also be executed by both the specific processing unit 290 of the data processing device 12 and the control unit 46A of the smart device 14. Furthermore, the specific processing unit 290 of the data processing device 12 acquires or collects information necessary for processing from the smart device 14 or external devices, etc., and the smart device 14 acquires or collects information necessary for processing from the data processing device 12 or external devices, etc.

For example, the collection unit may be implemented by the control unit 46A of the smart device 14 or the specific processing unit 290 of the data processing device 12. For example, the acquisition unit acquires step count data using the camera 42 or communication I/F 44 of the smart device 14, and this data is processed by the specific processing unit 290 of the data processing device 12. For example, the analysis unit is implemented by the specific processing unit 290 of the data processing device 12 and analyzes data from the collection unit and acquisition unit. For example, the generation unit is implemented by the specific processing unit 290 of the data processing device 12 and generates a cooking menu using a generation AI. For example, the provision unit is implemented by the output device 40 of the smart device 14 or the specific processing unit 290 of the data processing device 12 and provides the generated cooking menu to the user. The correspondence between each unit and the device or control unit is not limited to the above examples and various modifications are possible.

In the above embodiment, an example configuration was described where specific processing is performed by the data processing device 12. However, the technology disclosed herein is not limited thereto, and specific processing may also be performed by the headset-type terminal 314.

### Fourth Embodiment

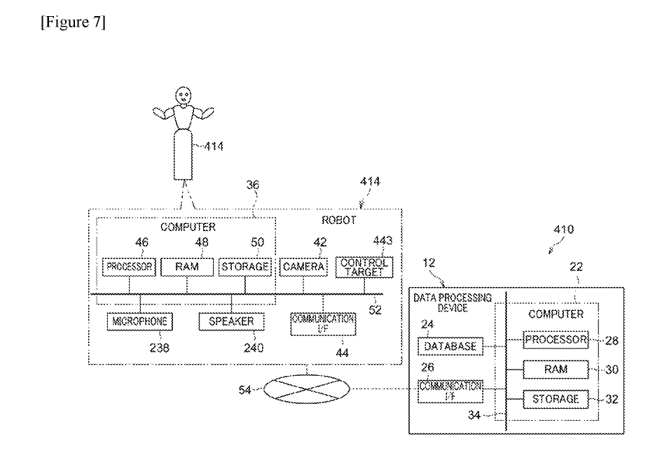

FIG. 7 shows an example configuration of the data processing system 410 according to the fourth embodiment.

As shown in FIG. 7, the data processing system 410 includes a data processing device 12 and a robot 414. An example of the data processing device 12 is a server.

The data processing device 12 includes a computer 22, a database 24, and a communication I/F 26. The computer 22 is an example of a "computer" related to the technology of this disclosure. The computer 22 includes a processor 28, RAM 30, and storage 32. The processor 28, RAM 30, and storage 32 are connected to a bus 34. The database 24 and communication I/F 26 are also connected to the bus 34. The communication I/F 26 is connected to a network 54. An example of the network 54 include a WAN (Wide Area Network) and/or a LAN (Local Area Network).

Robot 414 includes a computer 36, a microphone 238, a speaker 240, a camera 42, a communication I/F 44, and a control target 443. Computer 36 includes a processor 46, RAM 48, and storage 50. Processor 46, RAM 48, and storage 50 are connected to bus 52. Furthermore, microphone 238, speaker 240, camera 42, and controlled object 443 are also connected to bus 52.

Microphone 238 receives voice input from user 20 to accept instructions or other commands. Microphone 238 captures the voice input from user 20, converts the captured voice into audio data, and outputs it to processor 46. Speaker 240 outputs audio in accordance with instructions from processor 46.

Camera 42 is a compact digital camera equipped with an optical system, such as a lens, aperture, and shutter, and an imaging element, such as a CMOS (Complementary Metal-Oxide-Semiconductor) image sensor or a CCD (Charge Coupled Device) image sensor.

Device) image sensor. It captures images of the user's surroundings (e.g., within a field of view equivalent to that of a typical healthy individual).

The communication I/F 44 is connected to the network 54. The communication I/Fs 44 and 26 manage the exchange of various information between processor 46 and processor 28 via network 54. The exchange of various information between processor 46 and processor 28 using communication I/F 44 and 26 is performed in a secure state.

The control target 443 includes a display device, LEDs for the eye section, and motors for driving the arms, hands, legs, etc. The posture and gestures of robot 414 are controlled by controlling the motors for the arms, hands, legs, etc. Part of the robot 414's emotions can be expressed by controlling these motors. Furthermore, the robot 414's facial expressions can also be expressed by controlling the light emission state of the LEDs in its eyes.

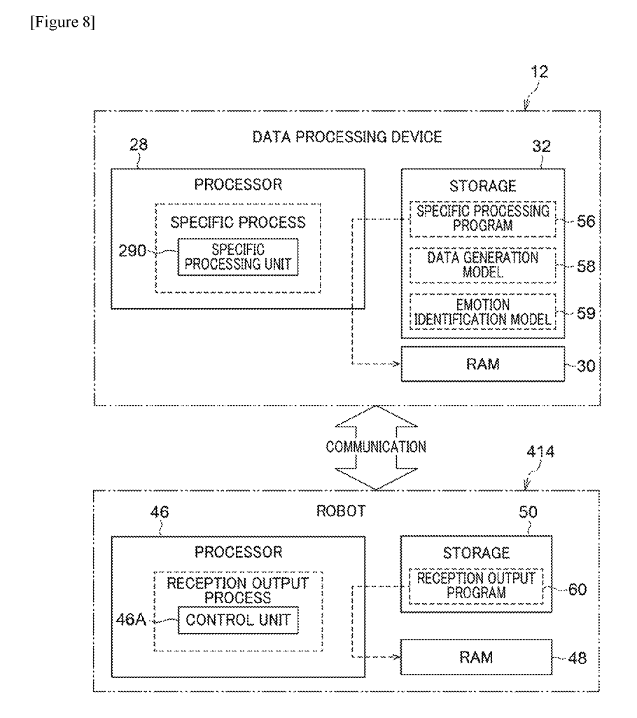

FIG. 8 shows an example of the main functions of the data processing device 12 and the robot 414. As shown in FIG. 8, specific processing is performed by the processor 28 in the data processing device 12. The specific processing program 56 is stored in the storage 32.

The specific processing program 56 is an example of a "program" related to the technology of this disclosure. The processor 28 reads the specific processing program 56 from the storage 32 and executes the read specific processing program 56 on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and the emotion identification model 59 are used by the specific processing unit 290.

In robot 414, reception output processing is performed by processor 46. Storage 50 stores a reception output program 60. Processor 46 reads the reception output program 60 from storage 50 and executes the read reception output program 60 on RAM 48. Reception output processing is realized by the processor 46 operating as a control unit 46A according to the reception output program 60 executed on RAM 48.

Next, the specific processing performed by the specific processing unit 290 of the data processing device 12 is described. The various parts of the system described below are implemented by the data processing device 12 and the robot 414. In the following description, the data processing device 12 is referred to as the "server," and the robot 414 is referred to as the "terminal."

### Example 1

The flow of the specific processing is the same as that described in Example 1 of the first embodiment, so the explanation is omitted.

### Application Example 1

The flow of the specific processing is the same as that described in Example 1 of the first embodiment above, so the description is omitted.

The specific processing unit 290 transmits the result of the specific processing to the robot 414. In the robot 414, the control unit 46A causes the speaker 240 and the control target 443 to output the result of the specific processing. The microphone 238 acquires audio indicating user input regarding the result of the specific processing. The control unit 46A transmits the audio data indicating the user input acquired by the microphone 238 to the data processing device 12. At the data processing device 12, the specific processing unit 290 acquires the audio data.

The data generation model 58 is a so-called generative AI (Artificial Intelligence). An example of the data generation model 58 is ChatGPT (registered trademark) (Internet search <URL: https://openai.com/blog/chatgpt>). The data generation model 58 is obtained by performing deep learning on a neural network. The data generation model 58 receives input of a prompt containing instructions, as well as inference data such as audio data representing sound, text data representing text, and image data (e.g., still image data or video data) representing images. The data generation model 58 infers based on the input inference data according to the instructions indicated by the prompt and outputs the inference result in one or more data formats, such as audio data, text data, and image data. The data generation model 58 includes, for example, text generation AI, image generation AI, and multimodal generation AI. Here, inference refers to, for example, analysis, classification, prediction, and/or summarization. The specific processing unit 290 performs the aforementioned specific processing while utilizing the data generation model 58. The data generation model 58 may be a fine-tuned model capable of outputting inference results from prompts that do not contain instructions. In this case, the data generation model 58 can output inference results from prompts that do not contain instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), and recurrent neural networks (RNN), generative adversarial networks (GAN), or naive Bayes, among others. The AI may perform various processing operations, but are not limited to these examples. Furthermore, the AI may be an AI agent. Also, when the processing of the aforementioned components is performed by AI, that processing may be performed in part or in whole by AI, but is not limited to such examples. Furthermore, processing performed by AI, including generative AI, may be replaced by rule-based processing, and rule-based processing may be replaced by processing performed by AI, including generative AI.

Furthermore, the processing performed by the data processing system 10 described above is executed by either the specific processing unit 290 of the data processing device 12 or the control unit 46A of the smart device 14, but it may also be executed by both the specific processing unit 290 of the data processing device 12 and the control unit 46A of the smart device 14. Furthermore, the specific processing unit 290 of the data processing device 12 acquires or collects information necessary for processing from the smart device 14 or external devices, etc., and the smart device 14 acquires or collects information necessary for processing from the data processing device 12 or external devices, etc.

For example, the collection unit may be implemented by the control unit 46A of the smart device 14 or the specific processing unit 290 of the data processing device 12. For example, the acquisition unit acquires step count data using the camera 42 or communication I/F 44 of the smart device 14, and this data is processed by the specific processing unit 290 of the data processing device 12. For example, the analysis unit is implemented by the specific processing unit 290 of the data processing device 12 and analyzes data from the collection unit and acquisition unit. For example, the generation unit is implemented by the specific processing unit 290 of the data processing device 12 and generates a cooking menu using a generation AI. For example, the provision unit is implemented by the output device 40 of the smart device 14 or the specific processing unit 290 of the data processing device 12 and provides the generated cooking menu to the user. The correspondence between each unit and the device or control unit is not limited to the above examples and various modifications are possible.

The above embodiment described a form where specific processing is performed by the data processing device 12, but the technology disclosed herein is not limited thereto; specific processing may also be performed by the robot 414.

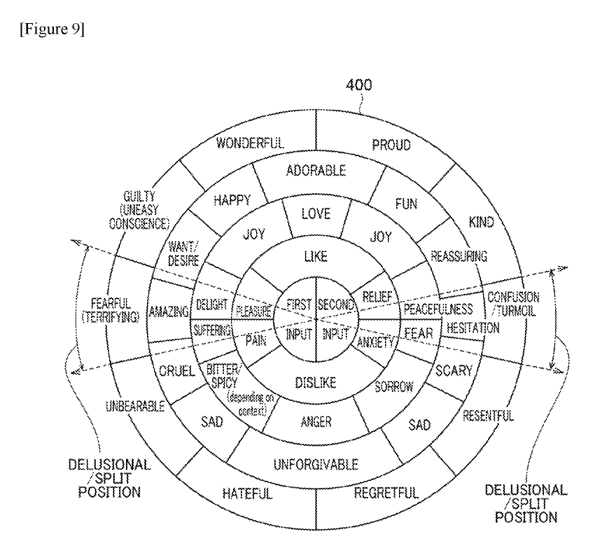

The emotion identification model 59, functioning as an emotion engine, may determine the user's emotion according to a specific mapping. Specifically, the emotion identification model 59 may determine the user's emotion according to an emotion map (see FIG. 9), which is a specific mapping. Furthermore, the emotion identification model 59 may similarly determine the robot's emotion, and the specific processing unit 290 may perform specific processing using the robot's emotion.

FIG. 9 is a diagram showing an emotion map 400 where multiple emotions are mapped. In the emotion map 400, emotions are arranged radially in concentric circles from the center. Emotions closer to the center of the concentric circles represent more primitive states. Emotions representing states or behaviors arising from mental states are placed further out in the concentric circles. Emotion is a concept encompassing affect and mental states. Generally, emotions generated from reactions occurring within the brain are placed on the left side of the concentric circles. Generally, emotions induced by situational judgment are placed on the right side of the concentric circles. Generally, emotions generated from reactions occurring within the brain and also induced by situational judgment are placed in the upper and lower directions of the concentric circles. Furthermore, the upper part of the concentric circle contains "pleasant" emotions, while the lower part contains "unpleasant" emotions. Thus, the Emotion Map 400 maps multiple emotions based on the structure of their origin, with emotions that tend to occur simultaneously mapped close together.

These emotions are distributed around the 3 o'clock position on the Emotion Map 400, typically oscillating between feelings of reassurance and unease. In the right half of the Emotion Map 400, situational awareness takes precedence over internal sensations, creating a calmer impression.

The inner part of Emotion Map 400 represents the mind, while the outer part represents behavior. Therefore, the further one moves toward the outer part of Emotion Map 400, the more visible the emotion becomes (manifesting in behavior).

Here, human emotions are based on various balances, such as posture and blood sugar levels. When these balances deviate from the ideal, it indicates a state of discomfort; when they approach the ideal, it indicates a state of comfort. Similarly, for robots, automobiles, motorcycles, etc., emotions can be created based on various balances, such as posture and battery level. When these balances deviate from the ideal, it indicates a state of discomfort; when they approach the ideal, it indicates a state of comfort. Emotion maps, for example, Dr. Mitsuyoshi's Emotion Map (Research on Speech Emotion Recognition and Neurophysiological Signal Analysis of Emotions, Tokushima University, Doctoral Dissertation: https://ci.nii.ac.jp/naid/500000375379). The left half of the emotion map displays emotions belonging to the "Reaction" area, where sensory perception dominates. The right half of the emotion map displays emotions belonging to the "Situation" domain, where situational awareness is dominant.

The emotion map defines two emotions that promote learning. One is the negative emotion around the center of the "repentance" or "reflection" area on the situation side. That is, when the robot experiences negative emotions like "I never want to feel this way again" or "I don't want to be scolded anymore." The other is the positive emotion around "desire" on the reaction side. That is, when the robot feels positive emotions like "I want more" or "I want to know more."

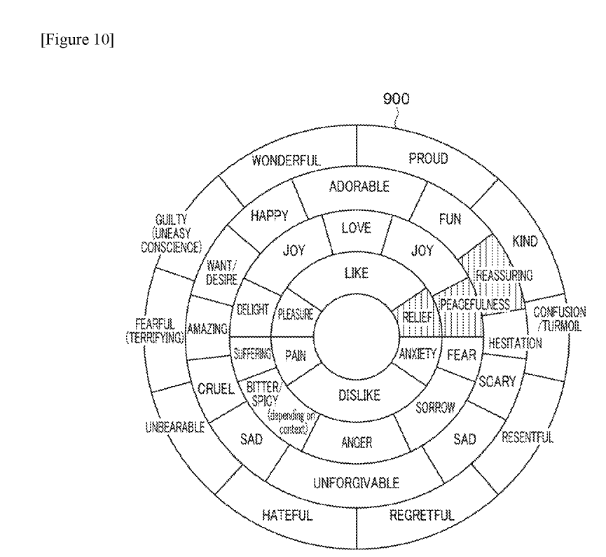

The emotion identification model 59 inputs the user input into a pre-trained neural network, obtains emotion values corresponding to each emotion shown in the emotion map 400, and determines the user's emotion. This neural network is pre-trained based on multiple training data sets, which are combinations of user input and emotion values corresponding to each emotion shown in the emotion map 400. Furthermore, this neural network is trained such that emotions positioned close to each other, as shown in the emotion map 900 in FIG. 10, have similar values. FIG. 10 illustrates an example where multiple emotions, such as "reassurance," "tranquility," and "encouragement," have similar emotion values.

The above description primarily explains the system according to the present disclosure in terms of the functions of the data processing device 12. However, the system according to the present disclosure is not necessarily implemented on a server. The system according to the present disclosure may be implemented as a general information processing system. For example, the present disclosure may be implemented as a software program operating on a personal computer or as an application operating on a smartphone, etc. The method according to the present disclosure may be provided to users in a SaaS (Software as a Service) format.

The above embodiment illustrated an example where specific processing is performed by a single computer 22. However, the technology of this disclosure is not limited thereto. Distributed processing may be performed by multiple computers, including computer 22, for specific processing. For example, data generation model 58 may be provided in an external device of data processing device 12, and said external device may generate data corresponding to input data. For example, the data generation model 58 may be provided in an external device of the data processing device 12, and data generation corresponding to input data may be performed in said external device.

The above embodiment described a configuration where the specific processing program 56 is stored in the storage 32. However, the technology disclosed herein is not limited to this. For example, the specific processing program 56 may be stored on a portable, computer-readable non-volatile storage medium, such as a USB (Universal Serial Bus) memory. The specific processing program 56 stored on the non-volatile storage medium is installed on the computer 22 of the data processing device 12. The processor 28 executes specific processing according to the specific processing program 56.

Alternatively, the specific processing program 56 may be stored on a storage device, such as a server, connected to the data processing device 12 via the network 54. Upon request from the data processing device 12, the specific processing program 56 is downloaded and installed on the computer 22.

It should be noted that it is not necessary to store the entire specific processing program 56 in a storage device such as a server connected to the data processing device 12 via the network 54, or to store the entire specific processing program 56 in the storage 32. It is also possible to store only a portion of the specific processing program 56.

Various types of processors can be used as hardware resources to execute the specific processing. Examples of processors include a CPU, which is a general-purpose processor that functions as a hardware resource for executing specific processing by executing software, i.e., a program. Additionally, processors may include dedicated electronic circuits, such as FPGAs (Field-Programmable Gate Array), PLDs (Programmable Logic Device), or ASICs (Application Specific Integrated Circuit), which are processors with circuit configurations specifically designed to execute particular processing. Each processor incorporates or connects to memory, and each processor executes specific processing by using this memory.

The hardware resources for executing specific processing may be comprised of one of these various processors, or may be comprised of a combination of two or more processors of the same or different types (e.g., a combination of multiple FPGAs, or a combination of a CPU and an FPGA). Furthermore, the hardware resources for executing specific processing may be a single processor.

Examples of configurations using a single processor include: First, a configuration where one processor is formed by combining one or more CPUs with software, with this processor functioning as the hardware resource executing specific processing. Second, there is a form using a processor that implements the entire system's functionality, including multiple hardware resources executing specific processing, on a single IC chip, as exemplified by a System-on-a-chip (SoC). Thus, specific processing is implemented as a hardware resource using one or more of the various processors described above.

Furthermore, regarding the hardware structure of these various processors, more specifically, electrical circuits combining circuit elements such as semiconductor devices can be used. Also, the specific processing described above is merely one example. Therefore, it goes without saying that within the scope not deviating from the main purpose, unnecessary steps may be omitted, new steps may be added, or the processing order may be changed.

The above descriptions and illustrations provide a detailed explanation of the aspects pertaining to the technology disclosed herein and represent merely one example of the disclosed technology. For example, the explanations regarding the configuration, functions, operations, and effects described above are examples of the configuration, functions, operations, and effects pertaining to the aspects of the disclosed technology. Therefore, it goes without saying that, within the scope that does not deviate from the essence of the technology of this disclosure, unnecessary parts may be omitted, new elements may be added, or replacements may be made to the above-described content and illustrations. Furthermore, to avoid confusion and facilitate understanding of the part pertaining to the technology of this disclosure, the above-described content and illustrations omit explanations of technical common knowledge and the like that are not particularly necessary for enabling the implementation of the technology of this disclosure.

All literature, patent applications, and technical standards described herein are incorporated by reference into this specification to the same extent as if each individual literature, patent application, and technical standard were specifically and individually incorporated by reference.

The following further discloses the above embodiments.

### Supplementary note 1

A system comprising a data input unit, an environmental data acquisition unit, and a layout generation unit. The data input unit receives information such as product type, size, price, inventory status, and past sales data from store managers. The environmental data acquisition unit performs a 3D scan of the store using LiDAR technology to acquire detailed physical data such as store dimensions, aisle widths, shelf heights, and product placements. The layout generation unit uses generative AI to analyze past sales data and customer movement patterns, generating the optimal product placement to maximize sales.

### Supplementary note 2

A system described in Supplementary note 1, further comprising a proposal unit that proposes specific product placements based on the generated layout. The proposal unit proposes placements that position best-selling products in locations easily visible to customers and place related products nearby to promote cross-selling. The proposal unit includes functionality allowing store managers to review proposed placements and make adjustments as needed. It further simulates the actual impact of proposed placements on sales and provides prediction results.

### Supplementary note 3

The system includes a function that uses prompt text fed to the generative AI to specifically instruct the desired store layout. The prompt text includes instructions such as "Place best-selling products in prominent locations and position related products nearby to promote cross-selling." The system has a function to predict sales after the proposed layout is implemented and present this to the manager, supporting efficient store operations.

### Explanation of Symbols

10, 210, 310, 410 Data Processing System

12 Data Processing Device

14 Smart Device

214 Smart Glasses

314 Headset-type devices

414 Robot

What is claimed is:

1. A system for automatically generating a customized room layout, comprising:
one or more data acquisition devices including at least one LiDAR scanner configured to capture three-dimensional spatial data representing an interior space of a room;
one or more processors operatively coupled to the data acquisition devices; and
a memory coupled to the one or more processors, the memory storing instructions which, when executed by the one or more processors, cause the system to:
receive the three-dimensional spatial data from the LiDAR scanner and generate a digital model of the room, including identifying structural features and spatial constraints of the room from the captured data;
receive user preference data indicating desired room layout requirements or style parameters;
generate, using a trained generative layout engine executed by the one or more processors, at least one proposed room layout configuration comprising placements of virtual furniture items within the digital room model, wherein generating the proposed room layout includes analyzing the identified spatial constraints of the room in view of the user preference data to optimize furniture arrangement under those constraints; and
output the proposed room layout configuration to a display device for visualization to the user;
wherein the system is configured to update the proposed room layout in substantially real-time in response to changes in the user preference data or additional spatial data, thereby improving the speed and interactivity of the layout generation process.

2. The system of claim 1, wherein the data acquisition device comprises a LiDAR sensor configured to generate three-dimensional point cloud data of the room, and the one or more processors are configured to detect planar surfaces corresponding to walls, floors, and ceilings from the point cloud data.

3. The system of claim 1, wherein the one or more processors include a graphics processing unit configured to generate a plurality of candidate room layout configurations in parallel and to rank the plurality of candidate configurations based on a spatial optimization metric.

4. The system of claim 1, wherein the generative layout engine comprises a trained neural network model trained on historical room layouts and furniture placement data, the neural network being configured to optimize furniture arrangements for aesthetic and functional fit, thereby improving the quality of layout proposals and the speed of generation compared to rule-based algorithms.

5. The system of claim 1, wherein the one or more processors include a graphics processing unit (GPU) or an AI accelerator configured to perform parallel processing of candidate layout configurations, thereby accelerating the generation of the room layout proposals.

6. The system of claim 1, wherein the user preference data comprises natural language descriptions of desired room style or usage, and the memory further stores an input interpretation module that uses natural language processing to translate the natural language descriptions into structured design parameters for the generative layout engine, thereby enhancing the interpretation of user inputs for layout generation.

7. A computer-implemented method for generating an interior room layout using a generative AI model, the method comprising:
capturing, via a LiDAR scanning device, three-dimensional spatial data of an interior room to obtain a digital representation of the room including dimensions and fixed features;
receiving user preference information for the room’s layout and design, the preference information comprising one or more desired style themes, functional requirements, or furniture selections;
processing the captured spatial data to identify room boundaries and obstacles, and constructing a digital room model with spatial constraints derived from the room’s geometry and existing features;
generating, by executing a trained generative layout algorithm on the one or more processors, at least one proposed room layout configuration that satisfies the user preference information, wherein generating the layout includes automatically selecting virtual furniture items and determining positions and orientations for the virtual furniture items within the digital room model based on the spatial constraints and the user preference information; and
providing the proposed room layout configuration for display to the user on a graphical user interface, including rendering a visual representation of the room with the virtual furniture in place.

8. The method of claim 7, wherein processing the captured spatial data comprises identifying restricted placement zones corresponding to doors, windows, and walkways, and excluding the restricted placement zones from candidate furniture placement regions.

9. The method of claim 7, wherein generating the proposed room layout configuration comprises executing the trained generative layout algorithm on a graphics processing unit to concurrently evaluate multiple layout hypotheses.

10. The method of claim 7, further comprising automatically updating the proposed room layout in response to detecting a modification in the user preference information or receiving additional LiDAR scan data for the room, wherein said updating is performed in real-time to provide immediate feedback on design changes, thereby optimizing the interactive layout generation process.

11. A non-transitory computer-readable storage medium storing instructions that, when executed by one or more processors, cause the processors to perform a method comprising:
obtaining, via at least one LiDAR scanner, three-dimensional environment scan data of an interior room and constructing a digital model of the room from the scan data;
receiving user preference inputs for furniture layout in the room;
processing the digital room model to determine spatial constraints including room dimensions and locations of walls, doors, or existing objects;
applying a trained generative layout model to the spatial constraints and user preference inputs to compute at least one proposed arrangement of furniture within the digital room model, wherein the generative layout model uses machine learning to evaluate multiple arrangement possibilities and outputs an optimized furniture placement that satisfies the spatial constraints and user preferences; and
outputting data representing the proposed arrangement of furniture for display on a user device, such that the user can visualize the furniture placement within a virtual representation of the actual room space.

12. The non-transitory computer-readable storage medium of claim 11, wherein the instructions further cause the processors to generate a spatial occupancy grid from the digital room model and restrict furniture placement to unoccupied grid cells.

13. The non-transitory computer-readable storage medium of claim 11, wherein the instructions further cause the processors to simulate user movement within the proposed furniture arrangement and to modify furniture placement based on predicted congestion.

14. The non-transitory computer-readable medium of claim 11, wherein the generative layout model comprises a deep neural network trained on a dataset of room layouts, and the stored instructions further include instructions for pre-processing the environment scan data into a format suitable for input to the deep neural network, thereby optimizing the use of the environmental scan data to improve the accuracy and speed of the layout generation.
